(19) United States
(12) Patent Application Publication
(10) Pub. No.: US 2014/0265998 A1
(43) Pub. Date: Sep. 18, 2014

(54) POWER TRANSFER FOR MOBILE ELECTRONIC DEVICES

(71) Applicant: Sandia Corporation, Albuquerque, NM (US)

(72) Inventors: Gregory N. Nielson, Albuquerque, NM (US); Murat Okandan, Edgewood, NM (US); Jeffrey S. Nelson, Albuquerque, NM (US); Jose Luis Cruz-Campa, Albuquerque, NM (US); Vipin P. Gupta, Reno, NV (US)

(73) Assignee: Sandia Corporation, Albuquerque, NM (US)

(21) Appl. No.: 14/062,245

(22) Filed: Oct. 24, 2013

Related U.S. Application Data
(60) Provisional application No. 61/789,559, filed on Mar. 15, 2013.

(51) Int. Cl. H02J 7/00; G08B 5/36

(52) U.S. Cl. CPC H02J 7/0047; G08B 5/36
USPC 320/101; 340/686.1

(57) ABSTRACT

Described herein are various technologies pertaining to provision of energy to a rechargeable battery of a mobile electronic device. The mobile electronic device has an array of photovoltaic cells embedded therein or affixed thereto. The array of photovoltaic cells is electrically connected to the rechargeable battery of the mobile electronic device. A charging pad includes an array of optical emitters, which are configured to emit light when the mobile electronic device rests on or adjacent to the charging pad. A remotely situated light source acts as a luminaire and emits a directed beam of light towards the mobile electronic device to provide energy to the rechargeable battery.

### RELATED APPLICATION

This application claims priority to U.S. Provisional Patent Application No. 61/789,559, filed on Mar. 15, 2013, and entitled “POWER TRANSFER FOR WIRELESS ELECTRONIC SYSTEMS”, the entirety of which is incorporated herein by reference.

### STATEMENT OF GOVERNMENTAL INTEREST

This invention was developed under Contract DE-AC04-94AL85000 between Sandia Corporation and the U.S. Department of Energy. The U.S. Government has certain rights in this invention.

### BACKGROUND

Due to decreasing costs and increasing capabilities, mobile electronic devices (e.g., mobile telephones, tablet computing devices, etc.) have become ubiquitous. Typically, these devices are powered by rechargeable lithium ion batteries. When a user of a mobile electronic device ascertains that a charge of the battery is relatively low, the user electrically couples the battery to a wall outlet, thereby recharging the battery. After some period of time has passed (e.g., 2-4 hours), the user disconnects the mobile electronic device from the wall outlet and may then utilize such device.

Charging pads have been relatively recently designed to eliminate the inconvenience of plugging a mobile electronic device into a wall outlet. Instead, a user can simply rest the mobile electronic device on the charging pad. When the mobile electronic device is oriented properly on the charging pad, power can be transferred from the charging pad to the rechargeable battery of the mobile electronic device. While the user no longer needs to plug the mobile electronic device into the wall outlet, precise alignment between the mobile electronic device and the charging pad is required to recharge the battery of the mobile electronic device. Furthermore, the charging pad may be less energy efficient than the conventional approach of plugging the mobile electronic device directly into the wall outlet.

### SUMMARY

The following is a brief summary of subject matter that is described in greater detail herein. This summary is not intended to be limiting as to the scope of the claims.

Described herein are various technologies pertaining to mobile electronic devices, as well as methods and apparatuses for transferring energy to rechargeable batteries of respective mobile electronic devices. In an exemplary embodiment, a mobile electronic device, such as a mobile telephone, a tablet computing device, a laptop computing device, a remote control, a videogame controller, a camera, a battery operated toothbrush, a watch, a personal mobile medical device, or the like, can have integrated therein or affixed thereto an array of photovoltaic cells. For example, the photovoltaic cells can be microsystems-enabled photovoltaic (MEPV) cells, wherein an MEPV cell may be a polygon with a height between 0.05 mm and 5 mm, width between 0.05 mm and 5 mm, and a thickness between 0.001 mm and 5 mm. Furthermore, in an exemplary embodiment, the array of photovoltaic cells can comprise multi-junction photovoltaic cells, wherein each junction of a photovoltaic cell is of a different type, and each junction is independently contactable (e.g. junctions of different types in a photovoltaic cell need not be connected in series). The types of junctions can include, but are not limited to, indium gallium phosphide, gallium arsenide, silicon, germanium, etc. Furthermore, the array of photovoltaic cells can be configured to be adaptable to non-uniform illumination across the array of photovoltaic cells. For instance, the array of photovoltaic cells can include a first series-connected string of photovoltaic cells and a second series-connected string of photovoltaic cells, wherein the first series-connected string and the second series-connected string are electrically connected in parallel.

Also described herein is a charging pad that is configured to transfer energy to a rechargeable battery of a mobile electronic device. An exemplary charging pad has an array of optical emitters embedded therein and/or affixed thereto, wherein optical emitters in the array of optical emitters are configured to emit light responsive to detecting that a mobile electronic device is resting on the charging pad and detecting a position of the mobile electronic device on the charging pad. In an exemplary embodiment, a footprint of the mobile electronic device on the charging pad can be determined, and only optical emitters in such footprint can be caused to emit light. The charging pad may additionally comprise a second array of optical emitters, wherein the second array of optical emitters can output signals that are indicative of an amount of charge in a battery of the mobile electronic device resting on the charging pad.

In yet another exemplary embodiment, lighting can be selectively controlled to direct a beam of focused light towards the array of photovoltaic cells on a mobile electronic device. For example, by way of a plurality of possible techniques, a location of a mobile electronic device in a particular special region can be determined. Based upon the location, a light source that is capable of acting as a luminaire can emit a focused beam of light towards the mobile electronic device (and thus, the array of photovoltaic cells embedded in the mobile electronic device or affixed to the mobile electronic device). Therefore, for example, an individual can place the mobile electronic device on a coffee table, end table, nightstand, etc., and light in the environment can be selectively directed to the mobile electronic device, where photovoltaic cells transform the light into electrical energy, which is then provided to a rechargeable battery of the mobile electronic device. As used herein, light is intended to encompass electromagnetic radiation that is part of the electromagnetic spectrum; accordingly the light referred to herein, whether emitted or received, may or may not be visible to the human eye.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is an isometric view of an exemplary mobile electronic device.

FIG. 2 is a functional block diagram of an exemplary mobile electronic device.

FIG. 3 is an isometric view of an exemplary protective case for a mobile electronic device.

FIG. 4 is an isometric view of an exemplary charging pad.

FIG. 5 is a functional block diagram of an exemplary charging pad.

FIG. 6 is a cross-sectional view of an exemplary system that includes a mobile electronic device and a charging pad.

FIG. 7 illustrates an exemplary system that facilitates transferring energy to a rechargeable battery of a mobile electronic device.

FIG. 8 illustrates an exemplary array of photovoltaic cells.

FIG. 9 illustrates an exemplary sub-module of photovoltaic cells that can be included in the exemplary array of photovoltaic cells.

FIG. 10 illustrates exemplary strings of photovoltaic cells that are coupled in parallel.

FIG. 11 illustrates an exemplary multi-junction photovoltaic cell.

FIG. 12 is a flow diagram illustrating an exemplary methodology for manufacturing a mobile electronic device to include an array of photovoltaic cells.

FIG. 13 is a flow diagram illustrating an exemplary methodology for forming a charging pad that is configured to transfer energy to a rechargeable battery of a mobile electronic device.

FIG. 14 is a flow diagram illustrating an exemplary methodology for transferring energy from a charging pad to a rechargeable battery of a mobile electronic device.

FIG. 15 is a flow diagram illustrating an exemplary methodology for transferring energy from a light source to a rechargeable battery of a mobile electronic device.

FIG. 16 illustrates an exemplary computing system.

### DETAILED DESCRIPTION

Various technologies pertaining to providing energy to a rechargeable battery of a mobile electronic device are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by a single system component may be performed by multiple components. Similarly, for instance, a single component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Additionally, as used herein, the term “exemplary” is intended to mean serving as an illustration or example of something, and is not intended to indicate a preference.

Various technologies pertaining to providing energy to a rechargeable battery of a mobile electronic device are described herein. For instance, a mobile electronic device can have photovoltaic cells (PV cells) embedded directly therein or affixed thereto, wherein the PV cells can be configured to harvest energy from ambient light or directed light having a particular wavelength (e.g., a wavelength that corresponds to a bandgap of at least one material in a PV cell). Further, also described herein is a charging pad that comprises a plurality of optical emitters (e.g., light emitting diodes (LEDs)), wherein resting the mobile electronic device on the charging pad with the PV cells facing the LEDs causes the PV cells to harvest energy from light emitted by the LEDs. For example, when a mobile electronic device is placed on the charging pad, a determination can be made that the mobile electronic device has been placed on the charging pad, and a footprint of the mobile electronic device on the charging pad can be determined. The charging pad can cause LEDs in the footprint to emit light, thereby directing light to the PV cells in the mobile electronic device that face the LEDs. In an exemplary embodiment, the light emitted by the LEDs can have a wavelength of approximately 850 nm. In another exemplary embodiment, a remotely situated optical emitter can be configured to direct a beam of light (e.g., in the ultraviolet spectrum) to the mobile electronic device, and thus to the PV cells embedded therein or affixed thereto. For instance, a light source in a home environment can be configured to act as a luminaire, such that the light source can direct a beam of focused light to a particular location. Therefore, for example, when the mobile electronic device is rested at a particular location in a room, the light source can direct a focused beam of light towards the mobile electronic device.

With reference now to the drawings, an isometric view of an exemplary mobile electronic device 100 is illustrated. The mobile electronic device 100 is shown as being a mobile telephone; it is to be understood that aspects described herein are not so limited. For example, the mobile electronic device 100 may be a tablet (slate) computing device, a laptop computing device, a dedicated e-reader computing device, a multimedia player, a remote control, a videogame controller, an earpiece (e.g., a Bluctooth earpiece, a hearing aid, etc.), a watch, glasses or goggles that are configured with processing capabilities, amongst other items with rechargeable batteries. The mobile electronic device 100 includes a housing 102 having an external surface 104, wherein the housing 102 forms an interior region. While not shown, a rechargeable battery can be positioned in the interior region formed by the housing 102. The rechargeable battery may be any suitable type of battery, such as a lithium ion battery, a nickel cadmium battery, a nickel metal hydride battery, etc.

The mobile electronic device 100 further includes an array of PV cells 106 embedded in or affixed to the exterior surface 104 of the housing 102. As will be described in greater detail herein, PV cells in the array of PV cells 106 can be microsystems enabled photovoltaic (MEPV) cells, which are generally characterized by their respective miniature sizes. For instance, each cell in the array of PV cells 106 may have a length between 0.05 mm and 5 mm, may have a width of between 0.05 mm and 5 mm, and a thickness of between 0.001 mm and 5 mm. Accordingly, the array of PV cells 106 may include one to hundreds, thousands, or tens of thousands of individual PV cells. It is to be understood, however, that aspects described herein are not limited to MEPV cells. Furthermore, cells in the array of PV cells 106 can be multi-junction PV cells, wherein each junction in a multi-junction PV cell is independently contactable. Accordingly, junctions in a multi-junction PV cell in the array of PV cells 106 need not be connected in series. As an exemplary multi-junction PV cell in the array of PV cells 106 can be composed of different materials having differing bandgaps, the array of PV cells 106 can be configured to generate electric current over a wide range of the optical spectrum. Accordingly, the array of PV cells 106 can be configured to convert light in the visible spectrum to electrical energy, wherein such electrical energy is directed to the rechargeable battery (or electric componentry in the mobile electronic device 100), thereby extending an amount of time between required charges of the rechargeable battery of the mobile electronic device 100 (compared to an amount of time between required charges of conventional rechargeable batteries of mobile electronic devices). Additionally, as will be described in greater detail below, the array of PV cells 106 can also be configured to be particularly well-suited to harvest energy from directed light having a particular wavelength (e.g., in the ultraviolet (UV) spectrum or in the infrared (IR) spectrum).

Furthermore, due at least partially to the miniaturized nature of PV cells in the array of PV cells 106, PV cells in the array of PV cells 106 can be electrically configured such that the array of PV cells 106 is generally robust to non-uniform illumination across cells in the array of PV cells 106. For example, the array of PV cells 106 can comprise a plurality of strings of PV cells, wherein each string of PV cells includes a respective plurality of series-connected PV cells. As will be described in greater detail below, such series/parallel configuration generally prevents a lowest amount of current amongst all PV cells from being the amount of current output by the array of PV cells 106.

The array of PV cells 106 can be embedded in or affixed to the housing 102 by any suitable technique. In an exemplary embodiment, the array of PV cells 106 can be embedded in a clear coating, such as a polycarbonate, acrylic, or other suitable polymer. The array of PV cells 106 can be embedded in the housing 102 by way of thermoforming, injection molding, etc. Additionally, while not shown, circuitry may be included in the mobile electronic device 100 that facilitates delivering energy to the rechargeable battery of the mobile electronic device 100. For instance, the circuitry can be configured to perform maximum power point tracking, such that regardless of output of the array of PV cells 106, the circuitry tracks to the maximum power point. This can allow for voltage output by the array of PV cells 106 to move up and down, so long as a proper amount of power is being delivered to the rechargeable battery of the mobile electronic device 100.

As noted above, cells in the PV cells 106 array may be multi-junction cells, wherein each junction corresponds to a respective different material, and each junction is independently contactable. Such configuration is advantageous in that the array of PV cells 106 can efficiently harvest energy over a wide spectrum of light. For instance, materials can be selected such that the array of PV cells 106 efficiently harvest energy from UV light and IR light as well as visible light. Accordingly, for example, a PV cell in the array of PV cells 106 can comprise a silicon cell and a III-V cell, wherein the silicon cell is particularly well-suited for harvesting energy in the IR spectrum (e.g., light having a wavelength of approximately 850 nm), while the III-V cell may be particularly well-suited for harvesting energy from light in the visible spectrum (e.g., between 380 and 740 nm). Since the junctions of such two cells need not be connected in series, the multi-junction cell can efficiently harvest energy across a wide optical spectrum.

With reference now to FIG. 2, an exemplary block diagram of the mobile electronic device 100 is illustrated. As noted above, the interior region formed by the housing 102 can include a rechargeable battery 202. The array of PV cells 106 is positioned on the exterior of the housing 102. The mobile electronic device 100 optionally includes charge circuitry 204 that can be configured to perform power tracking in connection with transferring energy to the rechargeable battery 202.

The mobile electronic device 100 can additionally include a processor 206 and a memory 208, wherein the processor 206 is configured to execute instructions in the memory 208. The memory 208 can include a location component 210 that, when executed by the processor 206, is configured to identify a location of the mobile electronic device 100. For example, the mobile electronic device 100) can include a global positioning system (GPS) transceiver (not shown), and the location component 210 can determine an absolute location of the mobile electronic device 100 based upon output of the GPS transceiver. In another example, the location component 210 can employ triangulation techniques, for instance, to identify its global location (or its location relative to other computing devices). The mobile electronic device 100 additionally includes a wireless chip 211, wherein the wireless chip 211 can publish the location of the mobile electronic device 100 as determined by the location component 210. As will be described in greater detail below, the location of the mobile electronic device 100 can be employed by a light source to focus light towards the array of PV cells 106.

Turning now to FIG. 3, an isometric view of an exemplary protective case 300 that can be electrically coupled to a mobile electronic device is illustrated. For example, the protective case 300 may be an aftermarket product that can be electrically coupled to a rechargeable battery of, for example, a mobile telephone. The protective case 300 includes a casing 302 having an exterior surface 304. The case 300 can be mechanically attached to a mobile electronic device by any suitable means, including clips, elastic edges, etc. The exterior surface 304 of the casing 302 includes the array of PV cells 106. The casing 302 can be composed of any suitable material, including a plastic, a rubber composite, etc. Further, the array of PV cells 106 can be embedded in the casing 302 or affixed to the casing 302 using any suitable technique (e.g., thermoforming, injection molding, encapsulating epoxies, . . . ).

The case 300 can additionally include a connector 306 that can electrically couple the array of PV cells 106 with a rechargeable battery of a mobile electronic device to which the case 300 is mechanically attached. In an exemplary embodiment, the connector 306 may be a micro USB connector or other suitable connector that is configured to plug into a charging port of a mobile electronic device. In another example, many mobile telephones, for instance, have a removable backing, such that the battery and at least one connection is exposed when the backing is removed. Such removed backing may be replaced by the case 300, such that the connector 306 is hidden from view when the case 300 is mechanically attached to a mobile electronic device.

With reference now to FIG. 4, an isometric view of an exemplary charging pad 400 is illustrated. The charging pad 400 is particularly well-suited for charging the mobile electronic device 100 by way of direct delivery of light to the array of PV cells 106. Furthermore, it is to be understood that the charging pad 400 may be of a size that supports simultaneous charging of multiple mobile electronic devices that have arrays of PV cells respectively embedded therein or affixed thereto. In an exemplary embodiment, the charging pad 400 can include a body 402 that can be composed of a composite rubber. In another exemplary embodiment, the body 402 may be composed of a plastic, wood, etc. The charging pad 400 comprises an array 404 of optical emitters. In an exemplary embodiment, the optical emitters can be light emitting diodes. Further, for instance, the light emitting diodes may be gallium arsenide light emitting diodes that are configured to emit light at approximately 850 nm, which can correspond to near the edge of the bandgap of silicon (e.g., the array of PV cells 106 may include silicon cells). In an exemplary embodiment, the pad 400 may include a plug 406 that can be mated with a wall socket, such that the array of optical emitters 404 is powered by way of the wall socket.

In operation, the mobile electronic device 100 can be positioned on the charging pad 400, such that the array of PV cells 106 faces the array of optical emitters 404. In an exemplary embodiment, a footprint of the mobile electronic device 100 on the charging pad 400 may be smaller than the footprint of the array of optical emitters 404. A subset of optical emitters in the array of optical emitters 404 can be caused to emit light based upon a sensed location of the mobile electronic device 100 on the charging pad 400. Thus, for instance, only optical emitters that are covered by the mobile electronic device 100 (or the array of PV cells 106) are caused to emit light, while other optical emitters in the array of optical emitters 404 do not emit light.

Sensing of the location of the mobile electronic device 100 on the charging pad 400 can be accomplished in a variety of manners. For instance, the charging pad 400 may be equipped with capacitive sensing technologies, such that the location of the mobile electronic device 100 on the charging pad 400 can be ascertained. In another example, optical emitters in the array of optical emitters 404 may themselves act as sensors. Therefore, for example, optical emitters in the array of optical emitters 404 can be configured to act as sensors until light detected thereby is beneath a threshold (e.g., a shadow is created by the mobile electronic device 100 resting upon optical emitters in the array of optical emitters 404). Optical emitters that detect the shadow can be caused to emit light, thereby directing light to the array of PV cells 106 of the mobile electronic device 100. In yet another example, to assist in differentiating the mobile electronic device 100 from some other object, the charging pad 400 can include a wireless transmitter and can perform a handshake protocol with the mobile electronic device 100, wherein such handshake protocol indicates to the charging pad 400 that the mobile electronic device 100 is proximate thereto. For instance, the mobile electronic device 100 and the charging pad 400 can comprise respective near-field communication (NFC) chips, such that data that identifies the mobile electronic device 100 is transmitted from the mobile electronic device 100 to the charging pad 400 when the mobile electronic device 100 is placed in close proximity to the charging pad 400.

In an exemplary embodiment, the NFC chips can communicate via radio frequency signals and by way of any suitable protocol and/or frequency, such as over Bluetooth, Wi-Fi, or cellular network frequencies; or the communication between the charging pad 400 and the electronic device 100 can be accomplished through optical mechanisms. For instance, optical communication emitters and detectors can be embedded in both the charging pad 400 and the electronic device 100. The charging pad 400 can be further connected to a communication network via Ethernet or other communication channel, thus allowing the communication pathway between the electronic device 100 and the charging pad 400 to be a mechanism of connecting the electronic device 100 to the internet.

In the exemplary embodiment where the footprint of the electronic device 100 is essentially the same as the footprint of the charging pad 400, the necessity of locating the position of the device 100 may be unnecessary. A button or other user interface device can be located on the charging pad 400 that, when depressed by the user, can indicate to the charging pad 400 that the electronic device 100 has been placed on the charging pad 400. The user input in this embodiment becomes the method of detecting whether the electronic device is located properly for charging.

The charging pad 400 may further include a second array of optical emitters 408 that can be configured to output a signal that is indicative of an amount of charge of the rechargeable battery of the mobile electronic device 100 when the mobile electronic device 100 is placed on the charging pad 400. For instance, the second array of optical emitters 408 can output a signal that can be seen by a user of the mobile electronic device 100 that indicates when the mobile electronic device 100 has been fully charged. In another example, the second array of optical emitters 408 can emit a changing signal to indicate a state of charge of the battery (initially red, then transitioning to yellow, and finally transitioning to green, when the battery of the mobile electronic device 100 is fully charged). Such information can be received from the mobile electronic device 100 over a short-range communications channel.

Further, in an exemplary embodiment, the charging pad 400 may optionally include an array of PV cells and a rechargeable battery. In such an embodiment, the battery can be employed to power the array of optical emitters 404, and the array of PV cells can be employed to charge the battery (or directly power the optical emitters 404). Such an embodiment may be particularly well-suited for situations where the pad 400 may be left in ambient light throughout the course of the day, while the mobile electronic device 100 may be positioned in a pocket or handbag. Accordingly, the battery of the charging pad 400 can be charged over the course of the day by harvesting ambient light, and the battery of the charging pad 400 can power the array of optical emitters 104 when the mobile electronic device 100 is placed thereon. In such an embodiment, the plug 406 may optionally be removed from the charging pad 400. The form factor of this embodiment may be the carrying case of an electronic device that is worn on a belt. In accordance with such an embodiment, the carrying case can provide charging of the electronic device 100 when the electronic device 100 is placed into the carrying case (with integrated rechargeable battery).

In yet another exemplary embodiment, the array of optical emitters 404 can transmit data to the mobile electronic device 100 when the mobile electronic device 100 is rested thereon. For instance, optical emitters in the array of optical emitters can output a modulated light signal that is received by the array of photovoltaic cells 106. The modulated light may encode data that is desirably transmitted to the mobile electronic device 100. In such an embodiment, the mobile electronic device 100 may include an integrated circuit that can decode the data based upon the modulated light signal.

While the pad 400 is shown as being a portable pad, it is to be understood that the functionality described above as being associated with the charging pad 400 may be placed in any suitable surface. For example, a countertop, a table, a tray, a desk, a car console, a desktop, a nightstand, a belt holster, a purse pocket, a laptop bag, or any other surface where a mobile electronic device may be set against or put in proximity to for a relatively long period of time (e.g., five minutes or more). It is to be noted that the charging pad 400 can be flexible and need not be in intimate contact with the PV array on the electronic device 100, as in the case of a charging pad 400 embedded into the laptop pouch within a laptop bag.

As noted above, optical emitters in the array of optical emitters 404 may be LEDs, which emit light in a relatively narrow band. Accordingly, LEDs in the array of optical emitters 404 can be tailored to emit photons with an energy level at or only slightly higher than the bandgap of the PV cells in the array of PV cells 100, thereby allowing for high-efficiency transfer of energy between the LEDs and the PV cells of the array of PV cells 106. Additionally, LEDs typically emit light at a near perpendicular angle from the surface of the LED lights (e.g., from the surface of the pad 400). While this is not ideal for general lighting, it is desirable for the purposes of transferring energy to the array of PV cells 106 of the mobile electronic device 100, as it is desirable that all light emitted from LEDs facing the array of PV cells 106 impacts PV cells in the array of PV cells without scattering losses. In addition, the optical emitters need not include phosphors that are typically used in LED lighting to achieve white light, which can further enhance energy transfer efficiency.

The exemplary charging pad 400 can be constructed in a variety of manners. For instance, traditional electronics assembly techniques, such as pick-and-place LED lights onto a printed circuit board or flexboard can be undertaken. In another example, LEDs lights may be printed onto a substrate. Furthermore, an array of LED lights can be created using techniques currently used to create computer monitors and televisions (e.g., organic light emitting diodes (OLEDS) or LED illuminated liquid crystal display LCD technology).

Now referring to FIG. 5, an exemplary functional block diagram of the charging pad 400 is illustrated. The charging pad 400 may optionally include a rechargeable battery 502, such as a lithium-ion battery, a nickel cadmium battery, or the like. The charging pad 400 may further comprise an array of photovoltaic cells 504 that are generally configured to harvest energy from ambient and/or directed light. For example, as described above with respect to the mobile electronic device 100, the array of photovoltaic cells 504 may include MEPV cells, multi-junction cells, cells that are arranged in various series/parallel connections (such that energy harvested by the array of photovoltaic cells 504 is relatively robust to non-uniformity), etc.

The charging pad 400 further comprises the array of optical emitters 404, which may be powered by way of a wall outlet and/or the battery 502. The charging pad 400 further comprises a detector circuit 506 (or other suitable technology) that can be utilized in connection with detecting that the mobile electronic device 100 rests upon the charging pad 400, as well as location of the mobile electronic device 100 on the charging pad 400 (e.g., in an embodiment where the electronic device 100 has a smaller footprint than the charging pad 400). As noted above, the mobile electronic device 100 and the charging pad 400 can be configured with wireless communications capabilities (either RF or optical), such that the mobile electronic device 100 can inform the charging pad 400 when the mobile electronic device 100 is in close proximity to the charging pad 400. For example, the detector circuit 506 may include an NFC chip, and the charging pad 400 can likewise include an NFC chip. When the NFC chip of the charging pad 400 receives an indication that the NFC chip of the mobile electronic device 100 is in close proximity thereto, the detector circuit 506 can infer that any shadow on optical emitters in the array of optical emitters 404 is caused by the mobile electronic device 100 resting on the charging pad 400. Alternatively, capacitive sensing can be used to indicate the position of the mobile electronic device 100 on the charging pad 400. Another exemplary approach is to include active alignment indicating emitters placed in the corners of the PV array 106 to indicate to the charging pad 400 where the PV array 106 is located. Multiple other detection mechanisms are also contemplated.

Turning now to FIG. 6, a cross-sectional view 600 of the mobile electronic device 100 resting upon the charging pad 400 is illustrated. In the exemplary cross-sectional view 600, the mobile electronic device 100 is shown as comprising a plurality of photovoltaic cells 602-620. The charging pad 400) is shown as comprising a plurality of LED lights 622-656. As can be ascertained, a footprint of the mobile electronic device 100 is smaller than a footprint of the charging pad 400 that is covered by the LEDs 622-656. The charging pad 400 is provided power by the plug 406 or by internal batteries.

When the mobile electronic device 100 is placed on the charging pad 400, the charging pad 400 is configured to detect the location of the mobile electronic device 100 thereon, such that only LEDs beneath the mobile electronic device 100 are caused to emit light. Accordingly, in the example shown in FIG. 6, the LEDs 626-652 are caused to emit light as such LEDs 626-652 are under the mobile electronic device 100 when the mobile electronic device 100 rests on the charging pad 400. The LEDs 622, 624, 654, and 656 are not provided with power (do not emit light), thereby conserving energy. Furthermore, in an exemplary embodiment, the LED lights 622-656 can be configured to emit light in the ultraviolet or infrared spectrum, such that any light leaking from underneath the mobile electronic device 100 is not visually distracting to a user. Therefore, for instance, light emitted by the LED 652 that leaks from under the mobile electronic device 100 may not be visible to a user.

Now referring to FIG. 7, an exemplary system 700 that can be employed in connection with directing light to the array of PV cells 106 of the mobile electronic device 100 is illustrated. The mobile electronic device 100 can be placed in a location where such mobile electronic device 100 is typically stored and/or used. For instance, if the mobile electronic device 100 is a mobile telephone, tablet computing device, or the like, the mobile electronic device 100 may be placed on a coffee table, a countertop, an end table, a nightstand, etc. (where the array of photovoltaic cells 106 are exposed to the environment).

The system 700 further includes a light source 702, which is configured to act as a luminaire. For example, the light source 702 may include one or more optical emitters that can direct focused beams of light to a particular location. Furthermore, in an exemplary embodiment, the light source 702 can be configured to emit light in an ultraviolet spectrum, such that light can be directed to a location of the mobile electronic device 100 while the room that includes the light source 702 remains dark (from the perspective of the user). In an exemplary embodiment, the light source 702 can include a location determiner component 704 that can determine a location of the mobile electronic device 100 relative to the light source 702. The location determiner 704 can utilize any suitable technique when determining the location of the mobile electronic device 100 relative to the light source 702.

In an exemplary embodiment, the location determiner component 704 can output a broadcast signal that can be received by the mobile electronic device 100. Responsive to receiving the broadcast signal, the mobile electronic device 100 can establish a communications channel with the location determiner component 704 and can transmit its global location to the location determiner component 704. Thus, for example, the mobile electronic device 100 may include a GPS transceiver and can provide the location determiner component 704 with coordinates output by the GPS transceiver.

In another example, the location determiner component 704 can determine the location of the mobile electronic device 100 based upon use of a vision system 706. The vision system 706 may be used in connection with a video game apparatus, embedded in a television, or already existent in the environment that includes the system 700. The vision system 706 can be configured to output images that are indicative of location of the mobile electronic device 100 relative to the light source 702. Such images can be transmitted to the location determiner component 704, which can analyze the images to locate the mobile electronic device 100 therein. The location determiner 704 can further communicate with the mobile electronic device 100 to confirm that the mobile electronic device 100 is in relative close proximity to the light source 702 (e.g., by way of a communications protocol, such as Bluetooth). If the location of the vision system 706 is known relative to the location determiner component 704, then the location determiner component 704 can determine the location of the mobile electronic device 100 relative to the light source 702. The light source 702 may then be configured to direct the beam of light at the mobile electronic device 100, thus assisting in extension of the battery life of the mobile electronic device 100 and/or recharging the battery of the mobile electronic device 100.

With reference now to FIG. 8, the array of PV cells 106 is illustrated. In an exemplary embodiment, the array of PV cells 106 can be between 1 cm and 4 cm in length, and between 1 cm and 4 cm in width. Furthermore, the array of PV cells can be configured to output between 3 volts and 6 volts, although in other embodiments the array of PV cells 106 can be configured to output more or less voltage. Dimensions of the array of PV cells 106 will depend on the available area for collection (e.g., size of the electronic device), the power needs of the electronic device, and the efficiency and material of the cells used. Pursuant to a particular example, the array of PV cells 106 can be configured to output 4.2 volts. As will be understood by one skilled in the art, however, an amount of voltage that can be output by the array or PV cells 106 can depend upon an application in which the array of PV cells 106 is employed, and may be higher or lower than the range set forth above.

The array of PV cells 106 comprises a plurality of photovoltaic sub-modules 802-848. While the array of PV cells 106 is shown as including 24 photovoltaic sub-modules, it is to be understood that the array of PV cells 106 may include more or fewer photovoltaic sub-modules, depending upon the application in which the array of PV cells 106 is employed, amount of space available upon which to install the array of PV cells 106, as well as the arrangement of the photovoltaic sub-modules 802-848 in the array of PV cells 106.

In an exemplary embodiment, the photovoltaic sub-modules 802-848 can be electrically connected in parallel with one another. Therefore, each of the photovoltaic sub-modules can output approximately the same voltage (e.g., between 3 and 6 volts). In another exemplary embodiment, rather than each of the photovoltaic sub-modules 802-848 being electrically connected in parallel, at least a subset of the photovoltaic sub-modules 802-848 can be connected to a power management integrated circuit, wherein such integrated circuit can be configured to output desired voltage and/or current levels resulting from the power that is produced from the subset of the photovoltaic sub-modules 802-848 electrically connected thereto. For instance, the array of PV cells 106 can include a single integrated circuit that is connected to each of the photovoltaic sub-modules 802-848 directly. The power management integrated circuit can then cause a final amount of power to be output by the solar panel 100 to be at a predefined, desired level (voltage and current). In another exemplary arrangement, subsets of photovoltaic sub-modules can be coupled in parallel, and such subsets can be connected to the power management integrated circuit. For instance, a first subset of photovoltaic sub-modules can include the photovoltaic sub-modules 802, 804, 806 and 808, which can be electrically connected in parallel. Similarly, a second subset of photovoltaic sub-modules can include the photovoltaic sub-modules 810, 812, 814 and 816, which can be electrically connected in parallel. The first subset of photovoltaic sub-modules and second subset of photovoltaic sub-modules may then be connected to the integrated circuit, which performs power management to cause a desired amount of power to be output by the array of PV cells 106. Other arrangements are also contemplated and are intended to fall under the scope of the hereto-appended claims.

The arrangement of at least some of the photovoltaic sub-modules 802-848 in the array of PV cells 106 in parallel effectively reduces the potential of any of the photovoltaic sub-modules (or cells therein) from being damaged when one or more photovoltaic cells in the photovoltaic sub-modules are operating in reverse breakdown. As at least some of the photovoltaic sub-modules 802-848 are electrically arranged in parallel, current matching between modules need not occur when at least one of the photovoltaic sub-modules 802-848 is shaded. This effectively reduces an amount of power that can be dissipated across any one of the photovoltaic sub-modules, thereby reducing risk of damage to a photovoltaic sub-module in the array of PV cells 106 when at least a portion of such sub-module is shaded or light is non-uniform across cells in the array of PV cells 106.

Now referring to FIG. 9, an exemplary photovoltaic sub-module 900 that can be included in the array of PV cells 106 is illustrated. The photovoltaic sub-module 900 comprises a plurality of groups 902-940 of electrically connected photovoltaic cells, wherein the groups 902-940 are electrically connected in series. While the photovoltaic sub-module 900 is shown as including 20 groups, it is to be understood that a number and arrangement of groups in the photovoltaic sub-module 900 can depend upon a desired voltage output by the photovoltaic sub-module 900. Furthermore, while the photovoltaic sub-module 900 is shown as being a definable, physical sub-element of the array of PV cells 106, it is to be understood that a photovoltaic sub-module can be defined by a circuit that is employed to connect cells in the array of PV cells 106; both arrangements are intended to fall under the scope of the hereto-appended claims.

Pursuant to an example, the photovoltaic sub-module 900 can comprise any suitable number of groups, wherein each of the groups is configured to output a consistent voltage (e.g., 0.4 volts). If the photovoltaic sub-module 900 includes ten groups, then the output of such photovoltaic sub-module 900 can be 4 volts. Furthermore, as will be shown in an example herein, some of the groups may be connected in parallel. For instance, the photovoltaic sub-module 900 can comprise a first plurality of groups that are connected in series and a second plurality of groups that are connected in series, wherein the first plurality of groups and the second plurality of groups are connected in parallel.

In the example noted above, each of the groups 902-940 is configured to output approximately 0.4 volts. Even if a subset of the groups 902-940 are shaded in the array of PV cells 106, because the voltage output thereby is relatively low and the current passing through the groups 902-940 is relatively low (on the order of milliamps), even if individual cells in the groups are operating in reverse breakdown, insufficient power is dissipated across the groups 902-940 to cause such groups 902-940 (or cells therein) to suffer damage.

Now referring to FIG. 10, an exemplary group 1000 that can be included as one of the groups 902-940 in the photovoltaic sub-module 900 is illustrated. The group 1000 comprises a plurality of photovoltaic cells 1002-1032. Pursuant to an example, the photovoltaic cells 1002-1032 can be MEPV cells that are built using microfabrication concepts. For instance, the following references, which are incorporated herein by reference, describe the building of photovoltaic modules that comprise numerous photovoltaic cells using microfabrication techniques: Nielson, et al., “Microscale C-SI (C) PV Cells for Low-Cost Power”, 34^{th} IEEE Photovoltaic Specialist Conference, Jun. 7-10, 2009, Philadelphia, Pa., 978-1-4244-2950/90, and Nielson, et al., “Microscale PV Cells for Concentrated PV Applications,” 24^{th} European Photovoltaic Solar Energy Conference, Sep. 21-25, 2009, Hamburg, Germany 3-936338-25-6. In summary, such references describe one sun and concentrating systems with integrated micro-optical lenses, and further describe relatively thin cells that have been fabricated using epitaxial lift-off in Silicon (Si) and Gallium Arsenide (GaAs) with efficiencies exceeding 10%.

Accordingly, the photovoltaic cells 1002-1032 can be or include Si cells, GaAs cells, Indium Gallium Phosphorous (Phosphide) (InGaP) cells, etc. Therefore, it is to be understood that at least one of the photovoltaic cells 1002-1032 can be a III-V photovoltaic cell. Additionally or alternatively, the photovoltaic cells 1002-1032 can include at least one Germanium (Ge) photovoltaic cell. Still further, the photovoltaic cells 1002-1032 can be, or may be included in, multi-junction cells that include layers of differing types of photovoltaic cells with differing band gaps. Heterogeneously integrating (e.g., vertically stacking) different cell types with dielectric layers in between can yield high performance multi-junction cells, where a designer of a photovoltaic panel is free from lattice matching and series connected (e.g., current matching) constraints of monolithic cells.

In an exemplary embodiment, each of the photovoltaic cells 1002-1032 can be a multi-junction cell wherein, for each multi-junction cell, layers are integrally connected. This effectively creates a string of photovoltaic cells electrically connected in series in a relatively small amount of space. In another exemplary embodiment, as will be shown herein, cells in a multi-junction cell may not be integrally connected. In yet another exemplary embodiment, the photovoltaic cells 1002-1032 can be of the same type (silicon). Other arrangements of photovoltaic cells are also contemplated.

In an exemplary embodiment, the sub-module 1000 can comprise a first string of photovoltaic cells 1034, a second string of photovoltaic cells 1036, a third string of photovoltaic cells 1038, and a fourth string of photovoltaic cells 1040. The first string of photovoltaic cells 1034 comprises the photovoltaic cells 1002-1008 electrically connected in series. Similarly, the second string of photovoltaic cells 1036 comprises photovoltaic cells 1010-1016 electrically connected in series. The third string of photovoltaic cells 1038 comprises the photovoltaic cells 1018-1024 electrically connected in series, and the fourth string of photovoltaic cells 1040 comprises the photovoltaic cells 1026-1032 electrically connected in series. The first string of photovoltaic cells 1034, the second string of photovoltaic cells 1036, the third string of photovoltaic cells 1038, and the fourth string of photovoltaic cells 1040 are electrically connected in parallel.

As will be understood by one skilled in the art, different types of photovoltaic cells have different operating voltages. For instance, if the photovoltaic cells 1002-1032 are Ge cells, the operating voltage may be approximately 0.3 volts. If the photovoltaic cells 1002-1032 are Si cells, then the operating voltage can be approximately 0.6 volts. If the photovoltaic cells 1002-1032 are GaAs cells, then the operating voltage may be approximately 0.9 volts, and if the photovoltaic cells 1002-1032 are InGaP cells, then the operating voltage may be approximately 1.3 volts. Pursuant to an example, the photovoltaic cells 1002-1032 can be Si cells. In such an example, each of the strings of photovoltaic cells 1034-1040 outputs approximately 2.4 volts (a common voltage), and therefore the output of the group 1000 is approximately 2.4 volts. In another exemplary embodiment, strings 1034, 1036, 1038, and 1040 have different numbers of cells for the different cell types, approximating the common voltage. For example, in an exemplary embodiment, the first string of photovoltaic cells 1034 can include eight Germanium cells (8×0.3=2.4), the second string of photovoltaic cells 1036 can include four Silicon cells (4×0.6=2.4), the third string of photovoltaic cells 1038 can include three GaAs cells (3×0.9=2.7), and the fourth string of photovoltaic cells 1040 can include two InGaP cells (2×1.3=2.6). The slight voltage mismatch is tolerable, and if desired, a larger number of cells and a higher voltage can be used to provide more precise voltage matching. In another embodiment described earlier, power management circuitry can be used to independently boost the voltages generated by the series connections of different cell types to a common voltage. If the desired output of the array of PV cells 106 is approximately 4.2 volts, then the photovoltaic sub-module 900 can include two of the groups electrically connected in series. Therefore, each sub-module 802-848 in the array of PV cells 106 outputs approximately 4.8 volts, and the output of the array of PV cells 106 is thus approximately 4.8 volts.

With reference now to FIG. 11, a cross-sectional view of an exemplary heterogeneously (non-monolithic) integrated multi-junction photovoltaic cell 1100 is illustrated. The multi-junction photovoltaic cell 1100 comprises a plurality of photovoltaic cells: an InGaP cell 1102 initially receives light; a GaAs cell 1104 is immediately adjacent to the InGaP cell; a Si cell 1106 is immediately adjacent to the GaAs cell 104; and a Ge cell 1108 is immediately adjacent to the Si cell 1106. It is to be understood that other arrangements are contemplated by the inventors and are intended to fall under the scope of the hereto-appended claims. As noted above, in an exemplary embodiment, each cell 1102-1108 can be independently contactable; thus, the InGaP cell 1108 can be coupled to another InGaP cell from a different multi-junction cell in series, the Si cell 1106 can be coupled to another Si cell (or another type of cell) from a different multi-junction cell in series, etc.

The embodiments described in this document do not exclude the use of the charging pad as a docking station for laptops, cellphones, tablets or any other device needing a docking station where a mouse, keyboard, external monitor are connected optically through the charging pad. For example, the charging pad 400 can be configured with ports, connectors, etc., wherein the mobile electronic device 100 can couple to the charging pad 400 by way of such ports, connectors, etc. The charging pad 400 may then provide additional functionality to the mobile electronic device 100. For instance, when the mobile electronic device 100 is a tablet computing device, the charging pad 400 can include a keyboard and provide keyboard functionality that can be used with the tablet computing device.

Furthermore, through the use of wireless optical or RF communication channels available between the electronic device 100 and the charging pad 400, and with the inclusion of connecting ports and connectors between the charging pad 400 and displays, keyboards, mouse devices, printers, Ethernet connection points, and the like; the charging pad can become a wireless docking station for the electronic device 100 with no need to physically connect the electronic device 100 with the charging pad 400 using external connectors (e.g., power or data connectors). Additionally, due to the immediate connection of the charging pad into a wired network, there is no additional wireless (e.g., Wi-Fi or cellular) bandwidth congestion resulting from this wireless connection between the electronic device and the charging pad.

The aspects described herein are associated with various advantages over conventional mobile electronic devices and associated charging systems. For instance, with respect to the mobile electronic device 100 and the charging pad 400, the mobile electronic device 100 need not be oriented in any particular orientation on the surface of the charging pad 400. Further, as the PV cells in the array of PV cells 106 can be independently contactable multi-junction PV cells, such PV cells may be compatible with a variety of illumination sources. Accordingly, power transfer need not require a particular dedicated pad. Furthermore, light sources that act as luminaries can be employed as high-intensity dedicated power sources for mobile electronic devices. Still further, PV cells in the array of PV cells 106 may be fully embedded in the skin of the mobile electronic device 100, thus simplifying power transfer. Still further, in some embodiments, power cords need not be employed.

Moreover, as the array of PV cells 106 can be configured to harvest energy based upon ambient light, trickle charging is possible throughout the day. PV cells in the array of PV cells 106 can be configured to harvest energy from sunlight or artificial light. Additionally, relatively high current charging is made possible with dedicated lighting, either through the remotely located directed light from the light source 702 or from the PV cells being in close proximity to optical emitters in the charging pad 400. Furthermore, as noted above, due to the miniature size of the PV cells and the ability to have junctions therein independently contactable, shading or other variations of illumination can be handled, while still allowing for relatively efficient charging of the mobile electronic device 100.

Still further, transmission of energy by light to the mobile electronic device 100 may eliminate the need of a transformer interface between a light source and the mobile electronic device 100. An arrangement of connection of PV cells in the array of PV cells 106 can define power parameters (voltage and current) being delivered to the batteries. As noted above, a power conditioning integrated circuit can be employed if necessary, which can allow maximum power point tracking to enable higher efficiency power transfer. Still further, as noted above, the charging pad 400 can be employed to charge multiple devices at the same time, wherein such devices may have different operating voltage and current levels.

Additionally, the mobile electronic device 100 can be charged relatively efficiently when placed on the charging pad 400 by selecting a wavelength of light to be emitted by optical emitters on the charging pad 400, such that the wavelength is near the bandgap of cells in the array of PV cells 106. Furthermore, electromagnetic field emissions are highly localized, with virtually no light escaping from between the surface of the pad 400 and the mobile electronic device 100. In comparison to inductive or RF power transfer methods, this can reduce any interference that may exist between the charging pad 400 and other electronics, thereby potentially reducing health concerns that may arise from electromagnetic fields generated by conventional pads.

Still further, as the optical emitters are somewhat device-independent, the charging pad 400, or technology associated therewith, may be built into an environment infrastructure and can be compatible with virtually any portable computing device. Therefore, as noted above, the charging pad 400 may be included in a table, a desk, etc. When not used for charging, the charging pad 400 can be used for general lighting or information display needs, thereby providing the general utility for both the light source and the PV cells in the portable electronic devices, whether they are coupled together or working independently.

FIGS. 12-16 illustrate exemplary methodologies relating to transferring energy to a rechargeable battery of a mobile electronic device. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

With reference now to FIG. 12, an exemplary methodology 1200 that facilitates manufacturing a mobile electronic device to include an array of PV cells is illustrated. The methodology 1200 starts 1202, and at 1204, an array of MEPV cells are received. For instance, the PV cells may be multi-junction MEPV cells, wherein each junction in a cell is respectively independently contactable. At 1206, the array of MEPV cells is incorporated into a housing of a mobile electronic device. As indicated above, this can be done by way of thermoforming, injection molding, etc. At 1208, the array of MEPV cells are electrically coupled to a rechargeable battery of the mobile electronic device. In an exemplary embodiment, the array of MEPV cells can be directly coupled to the rechargeable battery of the mobile electronic device. The methodology 1200 completes at 1210.

Now referring to FIG. 13, an exemplary methodology 1300 that facilitates manufacturing a charging pad is illustrated. The methodology 1300 starts at 1302, and at 1304 an array of optical emitters is received. The array of optical emitters, for example, may include LED lights. At 1306, the array of optical emitters is incorporated into the charging pad. For instance, the array of optical emitters may be on a printed circuit board and may be placed in a recess of a pad that is composed of a rubber composite (e.g., similar to a mouse pad). At 1308, sensor technologies are incorporated into the charging pad. The sensor technologies can be utilized in connection with identifying a location of a mobile electronic device when it is rested on the charging pad. At 1310, the array of optical emitters and the sensor technology is coupled to a plug, which can be mated with a wall socket. Thus, the plug facilitates provision of electric power to the componentry of the pad. The methodology 1300 completes at 1312.

Now referring to FIG. 14, an exemplary methodology 1400 that facilitates charging a mobile electronic device through utilization of a charging pad is illustrated. The methodology 1400 starts at 1402, and at 1404, position of a mobile electronic device on a charging pad is detected. As noted above, any suitable detection technologies can be utilized in connection with detecting the position of the mobile electronic device on the charging pad, such as capacitive technologies, detecting weight of the mobile electronic device on the charging pad, etc. At 1406, a first subset of optical emitters is powered based upon the position of the mobile electronic device on the charging pad. In an exemplary embodiment, the first subset of optical emitters may be less than all of the optical emitters on the charging pad. That is, only optical emitters sensed to be directly underneath the mobile electronic device may be caused to emit light.

At 1408, a determination is made regarding whether the battery of the mobile electronic device is fully charged. If the battery is not fully charged, then the methodology 1400 returns to act 1404.

If, at 1408, it is determined that the battery of the mobile electronic device is charged, at 1410 power can be ceased to be provided to the optical emitters in the subset of optical emitters. At 1412, a signal is output that indicates that the battery of the mobile electronic device is charged. Such signal may be an audible signal that indicates that the battery of the mobile electronic device is charged. In another example, the signal can be in optical signal output by one or more optical emitters on the charging pad. The methodology 1400 completes at 1414.

Now referring to FIG. 15, an exemplary methodology 1500 that facilitates charging a battery of a mobile electronic device by way of directing light from a remotely situated light source to the mobile electronic device is illustrated. The methodology 1500 starts at 1502, and at 1504, a location of a mobile electronic device is received (relative to the light source). At 1506, optionally, an indication is received that a battery of the mobile electronic device is less than fully charged. For instance, the indication can be that the battery has less than 50% charge. In another example, the indication can be that the battery has less than 30% charge. In still yet another example, the indication can be that the battery has less than 10% charge. At 1508, a directed light beam is emitted based upon the location of the mobile electronic device and the indication that the battery of the mobile electronic device is less than fully charged. For example, an LED light in a remotely situated light source can be configured to generate a directed beam of light towards an array of PV cells on the mobile electronic, thereby charging the battery of the mobile electronic device. The methodology 1500 completes at 1510.

Referring now to FIG. 16, a high-level illustration of an exemplary computing device 1600 that can be used in accordance with the systems and methodologies disclosed herein is illustrated. For instance, the computing device 1600 may be used in a system that facilitates provision of energy to a rechargeable battery of a mobile electronic device. By way of another example, the computing device 1600 can be used in a system that facilitates determining location of a mobile electronic device on a charging pad. The computing device 1600 includes at least one processor 1602 that executes instructions that are stored in memory 1604. The instructions may be, for instance, instructions for implementing functionality described as being carried out by one or more components discussed above or instructions for implementing one or more of the methods described above. The processor 1602 may access the memory 1604 by way of a system bus 1606. In addition to storing executable instructions, the memory 1604 may also store location information, imagery, etc.

The computing device 1600 additionally includes a data store 1608 that is accessible by the processor 1602 by way of the system bus 1606. The data store 1608 may include executable instructions, charge states, etc. The computing device 1600 also includes an input interface 1610 that allows external devices to communicate with the computing device 1600. For instance, the input interface 1610 may be used to receive instructions from an external computer device, from a user, etc. The computing device 1600 also includes an output interface 1612 that interfaces the computing device 1600 with one or more external devices. For example, the computing device 1600 may display text, images, etc. by way of the output interface 1612.

Additionally, while illustrated as a single system, it is to be understood that the computing device 1600 may be a distributed system. Thus, for instance, several devices may be in communication by way of a network connection and may collectively perform tasks described as being performed by the computing device 1600.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A mobile electronic device comprising:
a housing that forms an interior region, the housing having an exterior surface;
a battery positioned in the interior region of the housing; and
an array of photovoltaic cells embedded in or affixed to the exterior surface of the housing, the array of photovoltaic cells comprising:
a first string of photovoltaic cells, the first string of photovoltaic cells comprising a first plurality of photovoltaic cells that are electrically connected in series; and
a second string of photovoltaic cells, the second string of photovoltaic cells comprising a second plurality of photovoltaic cells that are electrically connected in series, the first string of photovoltaic cells and the second string of photovoltaic cells electrically connected in parallel, the first string of photovoltaic cells and the second string of photovoltaic cells electrically connected to the battery.

2. The mobile electronic device of claim 1 being one of a mobile telephone, a tablet computing device, a watch, an earpiece, a remote control, a wireless mouse, a wireless keyboard, glasses, a laptop, a camera, an electric toothbrush, a video game controller, an automobile door remote, a personal portable medical device, a video camera, a room monitoring device, a thermostat, or a battery backup.

3. The mobile electronic device of claim 1, the array of photovoltaic cells comprising multi-junction photovoltaic cells, wherein each multi-junction photovoltaic cell in the array of photovoltaic cells comprises a respective plurality of independently contactable photovoltaic cells of differing types, the first plurality of photovoltaic cells and the second plurality of photovoltaic cells being of a same type.

4. The mobile electronic device of claim 3, the multi-junction photovoltaic cells comprising an indium gallium phosphide cell, a gallium arsenide cell, a silicon cell, and a germanium cell.

5. The mobile electronic device of claim 1, the array of photovoltaic cells comprising silicon photovoltaic cells.

6. The mobile electronic device of claim 1, length of the photovoltaic cells in the array of photovoltaic cells being between ½ mm and 5 mm, and width of the photovoltaic cells in the array of photovoltaic cells being between ½ mm and 5 mm.

7. The mobile electronic device of claim 1 included in a system, the system further comprising a charging pad, the charging pad comprising:
an array of optical emitters; and
a control circuit that causes a subset of optical emitters in the array of optical emitters to emit light responsive to receiving a signal that indicates that the mobile electronic device rests on the subset of optical emitters.

8. The mobile electronic device of claim 1, further comprising an optical emitter electrically coupled to the array of photovoltaic cells, the optical emitter configured to emit an optical signal that encodes data desirably transmitted to an external device.

9. A charging pad comprising:
an array of optical emitters; and
a detector circuit that causes a subset of optical emitters in the array of optical emitters to emit light responsive to receiving a signal that indicates that a mobile electronic device rests on the subset of optical emitters.

10. The charging pad of claim 9, the array of optical emitters being an array of light emitting diodes.

11. The charging pad of claim 9 further comprising a rechargeable battery that is electrically coupled to the array of optical emitters, the rechargeable battery configured to power the array of optical emitters.

12. The charging pad of claim 9 further comprising an array of photovoltaic cells, the array of photovoltaic cells configured to output current responsive to being impacted by light, the current directed to power the wireless electronic device.

13. The charging pad of claim 9 further comprising:
a circuit that receives a signal from the mobile electronic device that indicates an amount of charge of a battery of the mobile electronic device; and
an optical emitter that is electrically coupled to the circuit, the circuit causing the optical emitter to emit light based upon the signal from the mobile electronic device.

14. The charging pad of claim 9, wherein the detector circuit causes at least one optical emitter to output a modulated light signal, wherein data desirably transmitted to the mobile electronic device is encoded in the modulated light signal.

15. The charging pad of claim 9, wherein the subset of optical emitters in the array of optical emitters are configured to act as sensors, wherein optical emitters in the subset of optical emitters output respective signals that indicate that the mobile electronic device rests on the optical emitters in the subset of optical emitters.

16. The charging pad of claim 9 comprised by a system, the system comprising the mobile electronic device, the mobile electronic device comprising:
a housing that forms an interior region, the housing having an exterior surface;
a battery positioned in the interior region of the housing; and
an array of photovoltaic cells embedded in or affixed to the exterior surface of the housing.

17. The charging pad of claim 16, the array of photovoltaic cells comprising:
a first string of photovoltaic cells, the first string of photovoltaic cells comprising a first plurality of photovoltaic cells that are electrically connected in series; and
a second string of photovoltaic cells, the second string of photovoltaic cells comprising a second plurality of photovoltaic cells that are electrically connected in series, the first string of photovoltaic cells and the second string of photovoltaic cells electrically connected in parallel, wherein the first string of photovoltaic cells and the second string of photovoltaic cells are electrically connected to the battery.

18. The charging pad of claim 17, wherein the subset of optical emitters directs light to the array of photovoltaic cells when the mobile electronic device rests on the charging pad.

19. The charging pad of claim 9 configured as a docking station for the mobile electronic device, the charging pad comprising at least one of a display, a keyboard, and a touch-sensitive pad, the display configured to display graphical data output by the mobile electronic device, the keyboard and the touch-sensitive pad configured to provide input data to the mobile electronic device.

20. A system comprising:
a mobile electronic device; and
a charging pad that is configured to charge a battery in the mobile electronic device when the mobile electronic device rests on the charging pad, wherein the mobile electronic device comprises:
a housing that forms an interior region, the housing having an exterior surface, wherein the battery is positioned in the interior region of the housing; and
an array of photovoltaic cells embedded in or affixed to the exterior surface of the housing;
and wherein the charging pad comprises:
an array of optical emitters; and
a detector circuit that causes at least one optical emitter in the array of optical emitters to emit light responsive to receiving a signal that indicates that the mobile electronic device rests on the subset of optical emitters.
